(19) United States
(12) Patent Application Publication
(10) Pub. No.: US 2020/0256674 A1
(43) Pub. Date: Aug. 13, 2020

(54) INEXPENSIVE INSTRUMENT FOR MEASURING WAVE EXPOSURE AND WATER VELOCITY

(71) Applicant: The Regents of the University of California, Oakland, CA (US)

(72) Inventor: Jared Figurski, Santa Cruz, CA (US)

(73) Assignee: The Regents of the University of California, Oakland, CA (US)

(21) Appl. No.: 16/700,797

(22) Filed: Dec. 2, 2019

Related U.S. Application Data
(63) Continuation of application No. 15/880,310, filed on Jan. 25, 2018, now abandoned.
Application No. 15/880,310 is a continuation of application No. 14/127,120, filed on Jan. 30, 2014, now abandoned.
(60) Provisional application No. 61/501,226, filed on Jun. 26, 2011.

(51) Int. Cl. G01C 13/00; G01P 5/04; G01F 3/00

(52) U.S. Cl. CPC G01C 13/002; G01F 3/00; G01C 13/006; G01P 5/04

(57) ABSTRACT

A sea-floor tethered float instrument containing an accelerometer for measuring wave induced water velocity, ocean currents, relative swell kinetics and the like.

### RELATION TO OTHER APPLICATIONS

This application is a Continuation of U.S. patent application Ser. No. 15/880,310, filed Jan. 25, 2018, which is a Continuation of U.S. patent application Ser. No. 14/127,120, filed Jan. 30, 2014, now abandoned, which is a U.S. National Phase Application under 35 USC § 371 of PCT/US12/42852, filed Jun. 18, 2012, the entire content of which is hereby incorporated by reference, and claims the benefit of U.S. Provisional Application No. 61/501,226, filed Jun. 26, 2011.

### FIELD OF THE INVENTION

A sea-floor tethered float instrument containing an accelerometer for measuring wave induced water velocity, ocean currents, relative swell kinetics and the like.

### BACKGROUND

Ocean waves drive a wide variety of near-shore physical processes, structuring entire ecosystems through their direct and indirect effects on the settlement, behavior, and survivorship of marine organisms. However, wave energy remains difficult and expensive to measure.

### SHORT DESCRIPTION OF THE INVENTION

The invention is an inexpensive and easily constructed instrument for measuring wave-induced water velocities and calculating wave energy. The underwater relative swell kinetics instrument (URSKI) employs a subsurface float tethered by a short (<1 m) line to the seafloor. Contained within the float is an accelerometer that records the tilt of the float in response to passing waves. The URSKI device can be used to measure and record a time series of wave-induced or unidirectional water flows. Orbital velocities (oscillating) or flow velocities (unidirectional) are interpreted from the tilt of the buoy that is measured by the internal accelerometer. Wave energy can be calculated from these measurements.

Embodiments include the following: A device for measuring wave induced water velocity, the device comprising a submerged float anchored just above the substrate by a tether (for example <1 m, <1.5 m, <2 m, between 1 m and 3 m, between 1 m and 4 m, or between 1 m and 5 m), the submerged float comprising a protective housing, and within the protective housing, an accelerometer in operational communication with a processor and a memory for logging data, whereby the accelerometer detects and measures the tilt of the float and expresses such measurements in the form of data which is stored in the memory. The device may comprise a data port which may be a Universal Serial Bus (USB) port or a wireless port or any kind. In certain embodiments the device specifically not comprising a feature selected from the group consisting of: an acoustic Doppler velocimeter, and acoustic Doppler current profilers, and a dissolvable block, for example of plaster or gypsum which have been used with previous devices. Other embodiments include a method for measuring wave induced water velocity, the method comprising (a) providing and deploying the described device such that it generated data about tilt, velocity, position, movement, etc. (b) collecting and storing said data to memory, (c) downloading said data into a computer, (d) characterizing wave energy by summarizing data over intervals using either (i) hourly means of angles, or (ii) hourly standard deviations of accelerations. Other embodiments include a system for estimating mean wave energy over time, the system comprising a device, the device described whereby the accelerometer detects and measures the tilt of the float at set intervals by measuring, calculating and recording the mean of angle of the device, or the standard deviations of accelerations of the device, at said set intervals, and wherein such data is stored in the memory means, and wherein the system further comprises a computer comprising a processor programmed with code which when executed calculates wave energy. The system may generate a time series of measurements summarizing the angles calculated by the following equations over set intervals using equations 6 and/or 7 and may generate a relative estimate of orbital velocities using equation 9. The system may identify the presence, magnitude and direction of currents in wave-swept environments using average deflections of raw accelerations. In some embodiments the rotation of the float relative to the tether is restricted and in some embodiments the maximum tilt of the float is less than 70° to the vertical axis.

### SHORT DESCRIPTION OF THE FIGURES

FIG. 1. An expanded view of an URSKI. The housing is designed to separate in the center, allowing easy access to the acceleration logger for downloading. Air in the float provides buoyancy.

FIG. 2. Terms defining the equilibrium position of an URSKI float (circle) in water flowing at velocity u. URSKI horizontal position and the associated angle measured by the accelerometer (q) is defined by the balance between horizontal drag (Fd) and the horizontal component of FTension (Fr).

FIG. 3. Illustration showing how tilt of an URSKI (q) is calculated from instantaneous accelerations. As the logger tilts, the proportion of gravity recorded in the horizontal X- and Y-axes of the acceleration logger increases toward 1 g, allowing the calculation of q by simple geometry.

FIG. 4. Flow chart outlining the possible methods used to generate time series data from raw accelerations in X- and Y-axes of URSKIs. Method/calculates the angle associated with the average of accelerations over an interval and can be used with a force model to calculate water velocities (u). Method 2 yields relative values for u unless calibrated against an ADV or ADCP.

FIGS. 5A and B. Temporal variation of orbital velocities and measurements made by URSKIs over two field trials (A and B). URSKIs were precise (top panel). All URSKI designs were accurate (middle and bottom panels), showing good correlation with ubr measured in situ by an ADV and against ubs predicted by a CDIP swell model.

FIG. 6. shows plots of URSKI measurements and standard deviation (Std Dev) of accelerations, according to embodiments of the present invention.

### GENERAL REPRESENTATIONS CONCERNING THE DISCLOSURE

ub=maximum bottom orbital velocity. ubr=representative bottom orbital velocity. Ubs=significant maximum water velocity. 0=angle of tilt from the vertical axis. 0i=instantaneous angle of tilt.

The embodiments disclosed in this specification are exemplary and do not limit the invention. Other embodiments can be utilized and changes can be made. As used in this specification, the singular forms “a”, “an”, and “the” include plural reference unless the context clearly dictates otherwise. Thus, for example, a reference to “a part” includes a plurality of such parts, and so forth. The term “comprises” and grammatical equivalents thereof are used in this specification to mean that, in addition to the features specifically identified, other features are optionally present. Where reference is made in this specification to a method comprising two or more defined steps, the defined steps can be carried out in any order or simultaneously (except where the context excludes that possibility), and the method can optionally include one or more other steps which are carried out before any of the defined steps, between two of the defined steps, or after all the defined steps (except where the context excludes that possibility). Where reference is made herein to “first” and “second” features, this is generally done for identification purposes; unless the context requires otherwise, the first and second features can be the same or different, and reference to a first feature does not mean that a second feature is necessarily present (though it may be present). Where reference is made herein to “a” or “an” feature, this includes the possibility that there are two or more such features.

This specification incorporates by reference all documents referred to herein and all documents filed concurrently with this specification or filed previously in connection with this application, including but not limited to such documents which are open to public inspection with this specification.

### DETAILED DESCRIPTION OF THE INVENTION

The invention comprises a device, ‘underwater relative swell kinetics instrument’ (URSKI) for measuring wave-induced water velocities, calculating wave energy, and methods for using such a device. A detailed description of the invention is published in the paper titled ‘An inexpensive instrument for measuring wave exposure and water velocity’ by Jared D. Figurski et al., published in Limnol. Oceanogr. Methods 9:204-214 (2011); DOI: 10.4319/lom.2011.9.204; which is incorporated by reference for all purposes.

One novel aspect of the invention is the construction of the device itself. It is believed that no other device exists with the particular combination of mechanical features possessed by the present invention.

Another novel aspect of the invention is the concept and application of using a submerged buoy to record and respond to changes in the direction and magnitude of water flow, and using accelerometers to measure the change in tilt (and in some embodiments roll and yaw) of the buoy.

Another novel aspect is the method of mathematical analysis and transformation used to convert accelerometer readings in to values for water velocity, and a system comprising the URSKI device and software programmed to carry out such calculations.

Specifically, the URSKI device is novel because of its structure, and also novel in the method it uses to measure the magnitude and direction of water flow and in how those data are analyzed. The design of URSKIs (basically a submerged buoy on a short tether) and the application of accelerometers to measure tilt are a new approach for measuring water flow. Through specific analyses developed by the inventor, URSKIs can do the following things which no previous device is capable of doing in the manner described:
(1) Measure the magnitude and direction of orbital velocities (wave-induced flow) by calculating tilt (Eq 7) associated with time-averaged accelerations (method 1) or by calculating the standard deviation of accelerations (Eq 9) over time intervals (method 2).
(2) Identify the presence, magnitude and direction of currents in wave-swept environments using average deflections of raw accelerations.
(3) Measure the magnitude and direction of unidirectional water flow in wave-free environments by calculating tilt for time-averaged accelerations using calibrated instruments.

A variety of materials, components, and designs can be used to manufacture URSKIs but the physical principles and approach to data analysis outlined in the manuscript are conserved and define the novel aspects of this new technology.

A significant advantage of the present invention is the relatively low manufacturing cost and simplicity of the device. Comparable instruments cost between fifteen and twenty-five thousand dollars, whereas URSKI costs about one hundred dollars to manufacture.

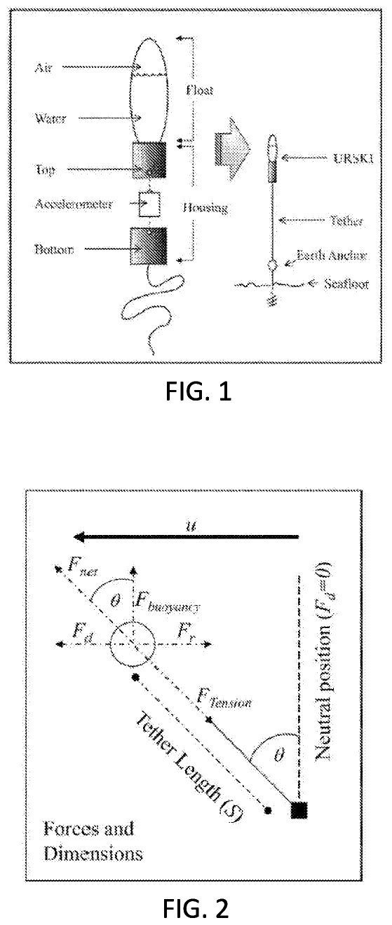

The device of the invention is referred to as the Underwater Relative Swell Kinetics Instrument (URSKI). It uses a submerged float anchored just above the substrate (seabed) by a tether, which moves freely with the water motion generated by waves. An inexpensive, off-the-shelf, accelerometer and data logger is mounted inside a protective housing and records the tilt of the float. See FIG. 1.

An URSKI device consists of a float, a housing, an accelerometer and data logger enclosed within the housing (the combination of accelerometer and data logger is referred to as an ‘acceleration logger’), a tether and an anchor (FIG. 1). Further the device may include a power source such as a battery functionally communicating with any element that requires power, such as the accelerometer and/or data logger. The device may also include a data port such as a universal serial bus (USB) port) which would be in functional communication with the acceleration logger. The device may optionally include a transmitter such as a radio frequency transmitter to transmit data from the acceleration logger.

The float may be of any kind such as a shaped enclosure enclosing any substance less dense than water, such as air, styrofoam, etc.

The housing may be made of any suitable material such as plastic or other polymer, molded to a suitable shape. In one exemplary embodiment the housing consists of two parts—a top part and a bottom part which fit together making a watertight seal to enclose the acceleration logger and other components.

The tether and the anchor may be of any suitable construction such as a polymer cord and a weight or a detachable fitting fixable to a stationary ballast present on the sea bed.

In one example used to prove the URSKI concept, ‘Pendant G’ acceleration loggers produced by Onset Corporation (UA-004-64) were selected for this application because they are small (58 Y 33 Y 23 mm), waterproof (to 30 m), inexpensive (<US$80), reasonably accurate (±0.105 g), have relatively high resolution (0.025 g), and enough memory for short deployments (64 kb). This is simply an example, and any acceleration logger may be used. The loggers record time series data that can be downloaded directly to a computer using an optic USB base station (U-1) or in some embodiments via a wireless connection. Interruption to continuity of time series caused by downloading can be eliminated by overlapping the sampling periods of replacement URSKIs with those they are replacing. Another approach is for divers to download the loggers underwater using a waterproof shuttle (U-DTW-1). Underwater downloading requires less than 3 min and also eliminates the need for replacement URSKIs. Tethers were made from 3-mm nylon parachute cord, and floats were made from inverted translucent beverage bottles (diameter: 61 mm, length: 225 mm overall length, volume: 520 mL). The floats were marked with a permanent marker to indicate the level to which they should be filled by divers in the field to achieve standardized air volumes. URSKI housings were made in two parts (Fig.) to allow divers to access the acceleration loggers: a section of PVC pipe (35 mm inner diameter) and a slip-on pipe coupler (length: 31.5 cm, weight: 110.6 g, internal volume: 136.3 cm3). All parts were fastened with nylon cable ties through holes in the pipe. Although URSKIs used in this study were attached to metal earth anchors that were screwed into sand, they can be attached to the sea floor in many ways including with weighted anchors or eyebolts screwed into or cemented into rocky substrates.

The invention includes methods for characterizing wave energy by summarizing URSKI measurements over intervals using (1) hourly means of angles, and (2) hourly standard deviations of accelerations (FIG. 4).

Method 1: Hourly means of angles. One approach for generating a time series of URSKI measurements is to summarize the angles calculated by Equations 9 or 10 over hourly intervals using an appropriate statistic. We suggest calculating the average magnitude of deflection that URSKIs experience over hourly intervals (but for some applications, percentiles may be more appropriate). Method 1 is preferred over Method 2 for calculating real (not relative) water velocity in the absence of an ADV (or similar instrument) for calibration because the relationship between angles of deflection and water velocity can be calculated from a force model. If relative magnitudes are all that are desired or calibrations against another instrument are possible, it is preferable to use Method 2 to summarize URSKI data for comparisons.

Method 2: Hourly standard deviations of accelerations. URSKI measurements can also be summarized using the standard deviations of accelerations over hourly periods. Wave orbital velocities are continuously changing in magnitude and the associated variance better characterizes the range of wave induced velocities than the mean. To generate a relative estimate of orbital velocities over a time interval, the standard deviation of the magnitude of the accelerations in the X-Y plane over that interval is calculated as: σ (x2 y2).

This approach provides relative estimates of orbital velocities, however, if actual rather than relative orbital velocities are desired, the values can be calibrated against an ADV or ADCP. The method using standard deviations rather than hourly means in wave environments is recommended because it is robust to intrinsic tilt error and does not require correction factors or prior calibrations.

### Embodiments

During two field trials totaling 358 h, we confirmed the accuracy and precision of URSKI measurements through comparison to velocities measured by an in situ acoustic Doppler velocimeter and those predicted by a standard swell model, and we evaluated how the dimensions of the devices, its buoyancy, and sampling frequency can be modified for use in a variety of environments.

### FURTHER DETAILED DESCRIPTION AND EMBODIMENTS

Principles of Operation

The maximum bottom orbital velocity (ub) generated by wave surge is a good indicator of forces exerted on substrates and marine organisms and is calculated for shallow water using linear theory as

$${u}_{\text{?}} = ( \frac{π H}{T} ) ( \frac{cosh ( ks )}{sinh ( kd )} ) \\ \text{?} \text{indicates text missing or illegible when filed} \qquad Equation 1$$

where H is wave height, T is wave period, d is water depth, s is height above substrate, k is wave number (=2p/L), and L is wavelength (Denny 1988). Wavelength can be approximated for shallow water as L=(gT2/2p) (tanh(4p2d/T2 g) 0.5, where g is acceleration due to gravity.

URSKIs move with wave surge in an arc defined by the length of rope (i.e., tether) that affixes them to the bottom (FIG. 2). The movement of URSKIs depends on the magnitude of water velocity and the wave period. To explain how URSKIs work, the effect of each component on URSKI movement will be addressed separately.

URSKI Response to Water Velocity

The response of URSKIs to the horizontal component of orbital velocities is analogous to how they would behave in a steady, unidirectional flow of water. As water flows past

URSKIs, they experience a lateral drag force (Fd).

$${F}_{d} = ( \frac{1}{2} ) \text{?} {u}^{2} \text{?} A \\ \text{?} \text{indicates text missing or illegible when filed} \qquad Equation 2$$

where pw is the density of seawater, u is water velocity relative to the URSKI, Cd is the coefficient of drag, and A is the projected area of the buoy and housing. URSKIs experience a vertical buoyant (Fb) and horizontal drag force (Fd) resulting in a net force (Fnet) with magnitude

$$\text{?} = \sqrt{\text{?} + \text{?}} \\ \text{?} \text{indicates text missing or illegible when filed} \qquad Equation 3$$

At equilibrium, Fnet will be both equal in magnitude and opposite in direction to the force (Ftension) applied by the tether, at which point the angle of deflection (A) of the buoy is equal to the angle of the Fnet vector (FIG. 2). Therefore 0 can be calculated as

$$θ = arc tan ( \frac{{F}_{2}}{{F}_{\text{?}}} ) \\ \text{?} \text{indicates text missing or illegible when filed} \qquad Equation 4$$

It is clear from Eqs. 2-4 that buoyancy, drag coefficient, and projected area are key components of URSKI design that determine the sensitivity of URSKIs to horizontal water motion. See FIG. 2.

URSKI Response to Wave Period

If displaced laterally and then released in still water, URSKIs oscillate in damped harmonic motion at a natural period (Tn) determined by the “stiffness” of the system and the length of the tether. For small deflections, the natural period is calculated as

$${{T}_{\text{?}}}_{n} = 2 π \sqrt{\frac{mS}{{F}_{\text{?}}}} \\ \text{?} \text{indicates text missing or illegible when filed} \qquad Equation 5$$

where S is the length of the tether and m is the effective mass (i.e., the sum of the URSKI's mass and the added mass of seawater that acts as if it moves with it). The added mass is calculated as αρ_{w}V; where α is the added mass coefficient, ρ_{w} is the density of seawater, and V is the volume displaced by an URSKI. In wave environments, the natural period of an URSKI must be less than the period of the waves it is measuring. Otherwise, an URSKI may underestimate water velocity if the natural period (Tn) is greater than the period of the waves and may overestimate water velocity, due to resonance, if the periods are equal. To avoid these problems, we designed the URSKI with a natural period shorter than 5 s, the periods of most ocean waves (Denny 1988), and furthermore, used computer simulations, based on the mathematical model presented for Nereocystis luetkeana by Denny et al. (1997), to ensure that URSKIs are sufficiently damped to prevent resonance. We also used computer simulations to verify that an URSKI has adequate buoyancy to avoid chaotic motion, a condition described by Denny and Hale (2003) for N. luetkeana that would have compromised the accuracy of an URSKI.

Adjusting URSKIs for Variable Conditions

URSKIs can be used across a wide range of wave conditions, however to maximize their sensitivity and accommodate maximum water velocities in different environments, some adjustments to tether length and buoyancy may be required. In general, greater buoyancy maintains URSKIs within operable amplitudes. While increasing buoyancy favorably reduces the natural period (Tn) of URSK1s, it comes at the cost of sensitivity. Low buoyancy, in contrast, maximizes sensitivity but increases the natural period of URSKIs and can reduce accuracy. This problem is overcome by shortening the tether, thereby reducing the natural period of URSK1s.

Calculating Instantaneous Tilt (θ)

Tilt is calculated from the proportion of gravity recorded in the horizontal axes of the accelerometer.

The instantaneous angle of an URSKI (θ i), therefore, is calculated from the magnitude of

$${θ}_{i} = arc sin ( \frac{\sqrt{{x}_{i}^{2} + {y}_{i}^{2}}}{g} ) \qquad Equation 6$$

where xi and yi are the measured accelerations for each axis at time i. The calculation of qi is based on the assumption that the URSKI is stationary because the accelerometer does not distinguish between acceleration due to a change in velocity and acceleration due to gravity. Although URSKIs are not stationary, maximum accelerations due to non-breaking waves are typically less than 1 m/s², about 10% of gravitational acceleration. In our simulations (with depth=9 m, height=1 m, period=10 s), lateral accelerations never exceed 5% of the gravitational acceleration recorded in the instrument's horizontal axes. Thus, the contributions of lateral accelerations can be ignored. Sources of instrument error and solutions An important potential source of error is intrinsic, derived from variation among instruments themselves. Nonvertical alignment of the accelerometer within the URSKI housing and asymmetries that cause URSKIs to lean are additive sources of error that are minimized by constructing URSKIs with standardized dimensions, symmetry, and balance. Some error, however, is unavoidable, and must be corrected for by either (1) calibrating instruments before use or (2) determining correction factors from the data following deployment. In both cases, correction factors are used to correct for tilt error in each axis by incorporating them into the calculation of the instantaneous angle

$${θ}_{i} = arc sin ( \frac{\sqrt{{( {x}_{i} - {x}_{\text{?}} )}^{2} + {( {y}_{i} - {y}_{\text{?}} )}^{2}}}{g} ) \\ \text{?} \text{indicates text missing or illegible when filed} \qquad Equation 7$$

where xc and yc are the tilt correction factors.

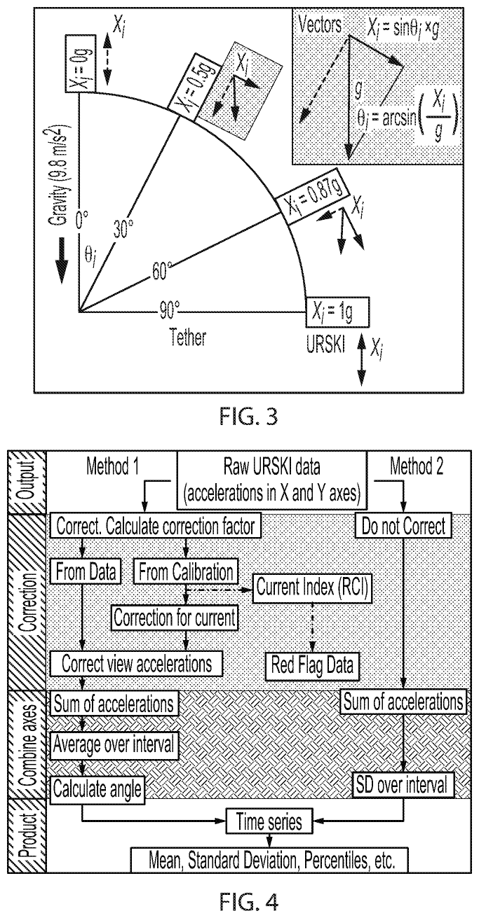

See FIG. 3 which is an illustration showing how tilt of an URSKI (q) is calculated from instantaneous accelerations. As the logger tilts, the proportion of gravity recorded in the horizontal X- and Y-axes of the acceleration logger increases toward 1 g, allowing the calculation of q by simple geometry.

Effect of Currents on URSKI Measurements

Another source of error is extrinsic, derived not from the instruments themselves but from water currents that can confound measurements of orbital velocities. Currents may cause error in URSKI measurements of wave energy (1) by damping oscillations of instruments (thereby reducing estimates of ub) and (2) by holding URSKIs at a tilt (thereby inflating estimates of ub), making spatial and temporal comparisons problematic.

To address this problem, we discuss how to analyze URSKI data to (1) generate a simple index of relative current strength for identifying periods of strong currents or (2) generate correction factors for URSKI measurements of waves.

URSKIs may also be used to measure the strength of unidirectional water flow, even in environments with waves. Current strength is estimated from the average deflection of URSKIs from their vertical position over appropriate time intervals (1,n). Average deflections are calculated using Eqs. 6, 7, or D2 by substituting xi and yi with the means of accelerations in the X- and Y-axes over that interval:

$${{x}^{\overline{\_}}}_{\text{?}} = \frac{1}{n} {\sum }_{i = 1}^{\text{?}} {x}_{i} and \\ {{y}^{\overline{\_}}}_{\text{?}} = \frac{1}{n} {\sum }_{i = 1}^{\text{?}} {y}_{i} \\ \text{?} \text{indicates text missing or illegible when filed} \qquad Equation 8$$

where i is all observations [1,n] during hour interval v. With calibration against a flow meter or by calculations from a force model, angles of deflection can be converted to flow velocity.

Generating Time Series

Instantaneous URSKI measurements do not individually estimate wave energy, but the distribution of these observations can be used to characterize wave energy. Over time, URSKIs sample at different phases of the waves, so measurements are combined over relevant time intervals, such as hours, to generate each estimate. Time intervals must be short enough to capture temporal variability across the times series yet include enough measurements to populate a distribution that characterizes the wave form. We suggest two methods for summarizing URSKI measurements over intervals using (1) hourly means of angles, and (2) hourly standard deviations of accelerations (FIG. 4).

Method 1: Hourly Means of Angles

One approach for generating a time series of URSKI measurements is to summarize the angles calculated by Eqs. 6, 7, or D2 over hourly intervals using an appropriate statistic. We suggest calculating the average magnitude of deflection that URSKIs experience over hourly intervals (but for some applications, percentiles may be more appropriate).

Method 1 is preferred over Method 2 for calculating real (not relative) water velocity in the absence of an ADV (or similar instrument) for calibration because the relationship between angles of deflection and water velocity can be calculated from a force model. If relative magnitudes are all that are desired or calibrations against another instrument are possible, it is preferable to use Method 2 to summarize URSKI data for comparisons.

Method 2: Hourly Standard Deviations of Accelerations

URSKI measurements can also be summarized using the standard deviations of accelerations over hourly periods. Wave orbital velocities are continuously changing in magnitude and the associated variance better characterizes the range of wave induced velocities than the mean. To generate a relative estimate of orbital velocities over a time interval, the standard deviation of the magnitude of the accelerations in the X-Y plane over that interval is calculated as:

σ\sqrt{x²+y²}) Equation 9

This approach provides relative estimates of orbital velocities, however, if actual rather than relative orbital velocities are desired, the values can be calibrated against an ADV or ADCP. The method using standard deviations rather than hourly means in wave environments is recommended because it is robust to intrinsic tilt error and does not require correction factors or prior calibrations.

Assessment

Materials and procedures

The accuracy of URSKIs was tested by comparing their performance to orbital wave velocities measured in situ by an ADV and to velocities generated by computer models provided by CDIP. In addition, the influence of specific attributes of URSKI design (i.e., tether length, buoyancy, and sampling frequency) on sensitivity and operable range was tested. To isolate the effects of each component, a baseline URSKI design was compared with three others, each with only a single change to either the frequency of sampling, tether length, or buoyancy (Table 1). Three replicates of each design were deployed adjacent to an ADV operated by the US Geological Survey as part of a long-term deployment at the end of the municipal wharf in Santa Cruz, Calif. (USA) at a depth of 9 m (MLLW). URSKIs were deployed over a level sandy bottom on the same isobath as the ADV, roughly parallel to shore. URSKIs were spaced 2 m apart to prevent them from tangling with each other, and replicates were arranged in an alternating configuration to ensure independence. Comparative trials were initiated just before the arrival of large swells (reaching significant waves heights of 4 m and peak wave periods of 13 s). The trials ran for 10 and 8 d, respectively.

TABLE 1
Specification of four URSKI designs used in this study and correlations with measurements
of orbital velocity made by an in situ ADV (u_{br}) and with calculations of orbital velocities
generated from a CDIP wave model (u_{bs}). URSKI data were summarized using Method
2. All correlations are highly significant (P < 0.0001). Bold values indicate
URSKI properties that differed from the other designs.

| | Specifications | | | | | | | Correlations | |
|---|---|---|---|---|---|---|---|---|---|
| | Float | | Tether | | | Sampling | | CDIP | ADV |
| URSKI | volume | Buoyancy | length | Tₙ | Area | frequency | N | u_{bs} (m/s) | u_{br} (m/s) |
| design | (mL) | (N) | (m) | (s) | (m²) | (Hz) | (hours) | Pearson R Values | |
| A | 75 | 0.3912 | 1 | 9.48 | 0.0171 | 0.1 | 165 | 0.90 | 0.95 |
| B | 75 | 0.3912 | 1 | 9.48 | 0.0171 | 0.025 | 358 | 0.90 | 0.93 |
| C | 300 | 2.6536 | 1 | 3.65 | 0.0171 | 0.025 | 358 | 0.92 | 0.93 |
| D | 75 | 0.3912 | 0.5 | 6.71 | 0.0171 | 0.025 | 358 | 0.93 | 0.95 |

In the deployment adjacent to the municipal wharf, the ADV sampling volume (−1 cm3) was located approximately 40 cm above the bed. The ADV system measured velocity and pressure at 4 Hz for 1024 s every 2 h, and data were transmitted to shore daily by Ethernet. Wave statistics were calculated from the instantaneous data following Wiberg and Sherwood (2008). For each 1025 s burst, representative bottom orbital velocity ubr was calculated as

$$θ = arctan ( \frac{{F}_{d}}{{F}_{b}} ) \qquad Equation 4$$

where u and v are the two horizontal components of velocity, and the primes indicate the difference from the burst mean. Significant wave height Hs and dominant wave period Td were calculated from the spectrum of wave orbital velocities. Model results in the form of Hs and Td for the location and time period of the trials were furnished by the Coastal Data Information Program, Integrative Oceanography Division, operated by the Scripps Institution of Oceanography (http://cdip.ucsd.edu/) based on buoys 029, 46042, 071, and 157 for ground swell and 46042 and 157 for seas.

Analyses

To determine the accuracy of the URSKI designs tested in this study, URSKI measurements were compared with independent estimates of ub generated by the CDIP model and the ADV. Estimates of significant maximum water velocity (ubs) for the CDIP model were calculated from Eq. 1 using hourly significant wave height and dominant period. ADV estimates of ubr were available for every other hour. URSKI hourly time series (averaging across replicates for each design) were calculated using both Methods 1 & 2 and were compared with ubs from the CDIP model and ubr from the ADV using correlation analyses. Hourly values of wave statistics and URSKI measurements were log transformed to improve normality. To evaluate precision (i.e., variation among replicates) for all URSKI designs, hourly standard deviations and coefficients of variation among replicates for each hour were calculated. Based on the assumption that replicate URSKIs experienced identical wave conditions (because they were along the same isobath and separated by no more than 30 m), standard deviations of hourly URSKI measurements were used as estimates of instrument error among replicates. Coefficients of variation [0064] for the upper and lower 10% of ubs (based on CDIP wave statistics) experienced during the trials were used to test the magnitude of instrument error at high and low wave energies. To test whether error among instruments would confound spatial or temporal comparisons of orbital velocities for each URSKI design, variance tests that indicate the proportions that instrument error contributed to overall variation of each trial were used. The proportions were calculated as (Pr_{σ2}=σ²ᵣ/[(σ₂ᵣ+σ²ₜ), where variance among replicate URSKIs (σᵣ), is the geometric mean of the variances among replicates of hourly data (summarized by Method 2) for each trial, and the temporal variance (σₜ) is among hourly means of replicate URSKIs over the trial. This approach scales the contribution of instrument error to overall variance between 0 (small) and 1 (large), thereby indicating the limit below which URSKIs cannot distinguish differences between loggers. The best URSKI design has the highest correlation with ubs and ubr, lowest standard deviation among replicates, and the lowest variance in proportion to overall variance.

Results

Wave conditions during the trials were typical of winter swell events along the coast of central California, USA. Representative Hs measured by the on-site ADV ranged from 0.12 to 0.62 m (mean=0.30, sd=0.10) in trial 1 and 0.15 to 0.53 m (mean=0.38, sd=0.11) for trial 2. Td ranged from 7.19 to 14.46 s (mean=11.17, sd=1.80) in trial 1 and 10.57 to 15.33 s (mean=12.71, sd=1.12) in trial 2. ubr ranged from 0.05 to 0.21 m/s (mean=0.13, sd=0.04) during trial 1 and 0.07 to 0.26 m/s (mean=0.18, sd=0.05) during trial 2. URSKI recorded values tracked changes in ubs and ubr from both the

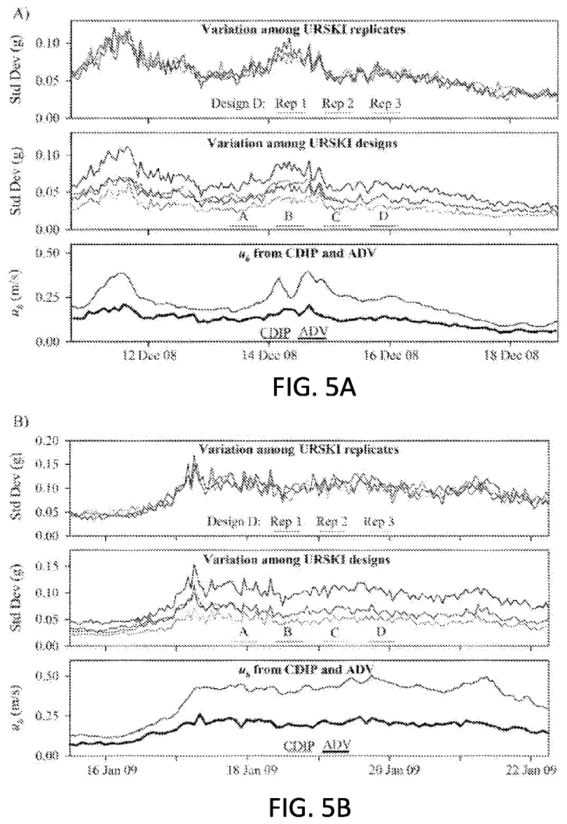

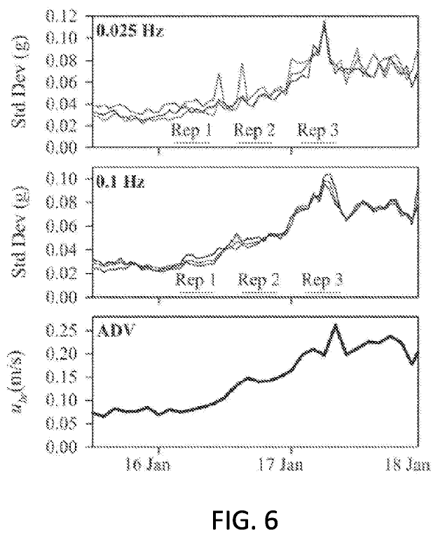

CDIP model and ADV, respectively (FIG. 5). ADV and CDIP estimates of ub over both trial periods were highly correlated (P<0.0001, Pearson r=0.93). URSKI measurements obtained using both Methods 1 and 2 were compared with values of ub measured by the ADV and modeled by CDIP. The strongest overall correlation was between ADV measurements and the hourly standard deviations from Method 2 (P<0.0001, Pearson r. 0.93) (Table 1). In general, standard deviations of accelerations by Method 2 showed stronger correlations with ADV measurements than did means of angles by Method 1 (Table 1). Of the different physical designs tested, URSKIs with short tethers showed the highest correlation, explaining 91% of the variation in ubᵣ (Table 1). However, the lowest performing designs, baseline and high buoyancy, still explained 86% of the variation in u_{br} (Table 1). Increasing the sampling frequency of the acceleration logger from 0.025 to 0.1 Hz (Design A) decreases variation among replicate URSKIs (FIG. 6).

URSKI precision was assessed using standard deviations and coefficients of variation (CV) among replicates of hourly measurements (Table 2). The CVs for all URSKI designs were overall quite low, ranging from 4.3-18.4%. Designs B-D demonstrated lower precision (using Method 2, CVs ranged from 12.2% to 18.4%) during periods with slowest water velocities (i.e., lowest 10%) compared with periods of high water velocity (i.e., upper 10%) when precision was greatest (CVs of 8.8% to 10.5%). This represented a 14% to 52% decrease in CV. Of these three designs, the one with the greatest buoyancy (design C) had poor precision (CV=18.4%) at low water velocities and excellent precision (CV=8.8%) at high water velocities. Design D with the short tether had good precision across the range of water velocities (CVs=12.2% and 10.5% for low and high, respectively). Design A, that sampled at the highest frequency demonstrated good precision at low water velocities (CV=12.5%) and excellent precision (CV=4.3%) at high water velocities. The power of URSKIs to discern spatial differences when single instruments were used at each location also was assessed. URSKIs were found to be capable of detecting differences as little as 4% to 7% using Method 2 (Table 3).

Discussion

URSKIs precisely and accurately estimated orbital velocities (FIG. 5), explaining as much as 91% of the variation in ubr measured by the ADV (Table 1), and distinguished differences of as little as 4% of the overall variation during the field trials (Table 3) conducted during moderate swells for central California. Whereas modifications to key components of URSKI design (e.g., tether length and buoyancy) may improve results, this study shows that URSKI performance is relatively robust across a range of design specifications, including increases of tether length from 0.5 to 1.0 m and buoyancy from 0.4 to 2.7 N. Where maximum performance is needed, the accuracy of URSKIs can be optimized by maximizing their sensitivity, keeping them from leaning past an angle of 70° , reducing their natural period, and avoiding chaotic motion. Although this can be accomplished with modifications to tether length, buoyancy, effective mass, or projected area, the latter two are difficult to modify once an URSKI is built. Therefore, it is suggested that URSKIs be constructed according to the directions here, but with adjustments to floats and tethers, as needed, for optimizing performance in different wave environments. The examples described employ a relatively small amount of memory in the acceleration loggers, however the invention is not limited to any particular memory capacity and the device may use memory of any kind or capacity, which is easily commercially available. The invention may employ higher or lower sampling frequencies than those used in the examples, and software-permitting, can employ burst sampling that would increase the accuracy of measurements. In this study, when sampling frequencies were increased, from 0.025 to 0.1 Hz, accuracy went up by 3.8% (Table 1; FIG. 6). Therefore, it is recommended that sampling be made at the highest frequencies possible and ideally at frequencies above 0.2 Hz, which is the\ smallest wave frequency commonly encountered. Time series of URSKI measurements can be used to make temporal or spatial comparisons of wave conditions. However, the appropriate statistic used for making those comparisons depends on the research questions being addressed. For instance, maximums or percentiles (e.g., 85, 95, or 99) are useful for comparing the upper end of wave forces experienced among locations or periods, whereas averages dampen the signal of extreme events but may better reflect differences in the overall wave energy experienced. The simplest use of URSKIs is for relative measurements of u. If true velocities, rather than relative, are required, they can be calibrated against other instruments such as ADVs or ADCPs, or u can be calculated from force models. Finally, the use of standard deviations of accelerations for summarizing hourly data (Method 2) is recommended because this approach is more robust than Method 1.

TABLE 2
Precision of URSKI designs. Standard deviations (SD) and coefficients of variation
(CV) were calculated among replicate URSKIs for the lower and upper 10% of u_{bs}.
Precision is greatest (lower CV) for the upper 10% of u_{bs}.

| | | Lower 10% of u_{bs} | | | | Upper 10% of u_{bs} | | | | All statistics | | | |
|---|---|---|---|---|---|---|---|---|---|---|---|---|---|
| Design | Method | N | SD | Mean | CV | N | SD | Mean | CV | N | Max | Min | Mean |
| A | 1 | 18 | 0.625 | 3.265 | 0.192 | 17 | 0.525 | 7.040 | 0.074 | 165 | 2.783 | 0.044 | 1.129 |
| B | 1 | 39 | 0.564 | 3.353 | 0.167 | 38 | 0.596 | 6.689 | 0.088 | 358 | 2.280 | 0.027 | 0.470 |
| C | 1 | 39 | 0.296 | 2.250 | 0.131 | 38 | 0.270 | 4.683 | 0.058 | 358 | 0.809 | 0.006 | 0.221 |
| D | 1 | 39 | 0.401 | 4.025 | 0.098 | 38 | 0.512 | 7.602 | 0.068 | 358 | 1.765 | 0.030 | 0.468 |
| A | 2 | 18 | 0.003 | 0.028 | 0.125 | 17 | 0.003 | 0.078 | 0.043 | 165 | 0.013 | 0.000 | 0.005 |
| B | 2 | 39 | 0.003 | 0.027 | 0.126 | 38 | 0.006 | 0.066 | 0.097 | 358 | 0.018 | 0.000 | 0.005 |
| C | 2 | 39 | 0.004 | 0.019 | 0.184 | 38 | 0.004 | 0.049 | 0.088 | 358 | 0.013 | 0.000 | 0.004 |
| D | 2 | 39 | 0.004 | 0.036 | 0.122 | 38 | 0.010 | 0.100 | 0.105 | 358 | 0.022 | 0.001 | 0.007 |

TABLE 3
Variance test used to determine the power of URSKIs to discern differences in magnitudes of orbital velocities. Prₒ₂
is the proportion that variance among replicate URSKIs (o²ᵣ) contributes to overall variance (o²ᵣ + o²ₜ) over the trials.
o²ₚᵣₒₚ thus indicates the minimum proportional difference in water velocities that URSKIs are capable of detecting.

| | | Trial 1 | | | Trial 2 | | | Combined Trials | | | |
|---|---|---|---|---|---|---|---|---|---|---|---|
| Design | Method | o²ᵣ | o²ₜ | o²ₚᵣₒₚ | o²ᵣ | o²ₜ | o²ₚᵣₒₚ | o²ᵣ | o²ₜ | o²ₚᵣₒₚ | n (hours) |
| a | 1 | 1.61520701 | 1.04688490 | 0.61 | 0.27123501 | 2.98397534 | 0.08 | 0.84421440 | 2.65354884 | 0.24 | 165 |
| b | 1 | 0.12984934 | 1.04484504 | 0.11 | 0.19305609 | 1.47955238 | 0.12 | 0.15554770 | 1.61045956 | 0.09 | 358 |
| c | 1 | 0.02698760 | 0.47838379 | 0.05 | 0.03873052 | 0.68737197 | 0.05 | 0.03181244 | 0.83083175 | 0.04 | 358 |
| d | 1 | 0.08811887 | 2.80753545 | 0.03 | 0.25378314 | 3.31274251 | 0.07 | 0.14263768 | 4.71328361 | 0.03 | 358 |
| a | 2 | 0.00002651 | 0.00008660 | 0.23 | 0.00000891 | 0.00053538 | 0.02 | 0.00001783 | 0.00024757 | 0.07 | 165 |
| b | 2 | 0.00000995 | 0.00012795 | 0.07 | 0.00001954 | 0.00021756 | 0.08 | 0.00001353 | 0.00023781 | 0.05 | 358 |
| c | 2 | 0.00001239 | 0.00007674 | 0.14 | 0.00001051 | 0.00014427 | 0.07 | 0.00001149 | 0.00014548 | 0.07 | 358 |
| d | 2 | 0.00001778 | 0.00035889 | 0.05 | 0.00005712 | 0.00058528 | 0.09 | 0.00003025 | 0.00065989 | 0.04 | 358 |

Conclusion, Comments and Recommendations

Coastal marine ecosystems are structured by physical processes. Wave energy, in particular, has important effects on the nearshore by altering the structure of coastlines and physical oceanography and, in turn, the diversity and productivity of biological communities. Fundamental to understanding these processes is our ability to measure wave exposure, but the high cost of oceanographic instrumentation is often a barrier to research in this area. URSKIs address this problem by being a simple, inexpensive, and easy to use tool for accurately measuring bottom orbital velocities. Because URSKIs are orders of magnitude less expensive than acoustic instruments, measurements can be replicated over much larger spatial scales and at much finer resolutions than were previously possible.

URSKIs are accurate, precise, and robust. Their performance can be optimized by making them all symmetrical and identical in construction and by appropriately adjusting tether length and buoyancy to accommodate different wave environments. They can also be used to measure unidirectional water flow and also, with development of a non-rotating tether, can measure flow direction. URSKIs can be used alone to measure water flow or can be used alongside ADVs and ADCPs to increase spatial scales and resolution of measurements. We anticipate that URSKIs will be used to address research questions in many disciplines (from physical oceanography to freshwater and marine ecology) because of their accuracy, low cost, and simplicity. URSKI designs presented in this study function well. In addition, directional data for swell or currents may be attained by restricting the rotation of URSKIs by replacing the nylon line with a non-rotating tether (e.g., fiberglass rod, cable) and pivot (e.g., chain-link joint). In this case, the proportions of acceleration values in the positive and negative directions of both horizontal axes can be used to calculate both the magnitude and direction of orbital velocities. Further development may also allow URSKIs to be used as flow meters for unidirectional flow, such as is found in rivers, creeks, and tidal flats.

1. A device for measuring wave induced water velocity, the device comprising a submerged float anchored just above the substrate by a tether, the submerged float comprising a protective housing, and within the protective housing, an accelerometer in operational communication with a processor and a memory for logging data, whereby the accelerometer detects and measures the tilt of the float and expresses such measurements in the form of data which is stored in the memory.

2. The device of claim 1 further comprising a data port.

3. The device of claim 2 wherein the data port is a Universal Serial Bus port.

4. The device of claim 1 specifically not comprising a feature selected from the group consisting of: an acoustic Doppler velocimeter, and acoustic Doppler current profilers, and a dissolvable block. of plaster or gypsum.

5. A method for measuring wave induced water velocity, the method comprising (a) providing and deploying a device, the device comprising a submerged float anchored just above the substrate by a tether, the submerged float comprising a protective housing, and within the protective housing, an accelerometer in operational communication with a memory for logging data, whereby the accelerometer detects and measures the tilt of the float and expresses such measurements in the form of data which is stored in the memory means, (b) collecting and storing said data, (c) downloading said data into a computer, (d) characterizing wave energy by summarizing data over intervals using (i) hourly means of angles, or (ii) hourly standard deviations of accelerations.

6. A system for estimating mean wave energy over time, the system comprising a device, the device comprising a submerged float anchored just above the substrate by a tether, the submerged float comprising a protective housing, and within the protective housing, an accelerometer in operational communication with a processor and a memory for recording, processing and logging data, whereby the accelerometer detects and measures the tilt of the float at set intervals by measuring, calculating and recording the mean of angle of the URSKI device, or the standard deviations of accelerations of the URSKI device, at said set intervals, and wherein such data is stored in the memory means, and wherein the system further comprises a computer comprising a processor programmed with code which when executed calculates wave energy.

7. The system of claim 6 wherein the method comprises generating a time series of measurements summarizing the angles calculated by the following equations over set intervals:
$${θ}_{i} = arc sin ( \frac{\sqrt{{x}_{i}^{2} + {y}_{i}^{2}}}{g} ) \qquad Equation 6$$
wherein the instantaneous angle of tilt of the device is θ i, and wherein xi and yi are the measured accelerations for each axis at time i, and
$${θ}_{i} = arc sin = ( \frac{\sqrt{{( {x}_{i} - {x}_{\text{?}} )}^{2} + {( {y}_{i} - {y}_{\text{?}} )}^{2}}}{g} ) \\ \text{?} \text{indicates text missing or illegible when filed} \qquad Equation 7$$
where xc and yc are the tilt correction factors.

8. The system of claim 6 wherein the method comprises generating a relative estimate of orbital velocities over a time interval by calculating the standard deviation of the magnitude of the accelerations in the X-Y plane over an interval by applying the following calculation:
σ(\sqrt{x²+y²}) Equations 9

9. The system of claim 6 wherein the method comprises identifying the presence, magnitude and direction of currents in wave-swept environments using average deflections of raw accelerations.

10. The system of claim 6 wherein the rotation of the float relative to the tether is restricted.

11. The system of claim 6 wherein the maximum tilt of the float is less than 70° to the vertical axis.
